(19) United States
(12) Patent Application Publication
(10) Pub. No.: US 2026/0358266 A1
(43) Pub. Date: Nov. 12, 2026

(54) METHOD AND SYSTEM FOR WORKPIECE ANALYSIS AND IMAGE PROJECTION

(71) Applicant: K2Ai, LLC, Oak Park, MI (US)

(72) Inventor: Kevin Richard Kerwin, Oak Park, MI (US)

(21) Appl. No.: 19/672,985

(22) Filed: May 11, 2026

Related U.S. Application Data
(60) Provisional application No. 63/803,675, filed on May 10, 2025.

(51) Int. Cl. G01N 21/88

(52) U.S. Cl. CPC G01N 21/8806; G01N 2021/8809; G01N 2021/8835

(57) ABSTRACT

A method includes utilizing a camera situated above a workpiece and has a field of view oriented downwards onto the workpiece to record an image feed of the workpiece; detecting a feature of the workpiece in at least a first image of the image feed; preparing a second image that includes a visual indicator to identify the feature; and utilizing a projector situated above the workpiece to project the second image directly onto the workpiece such that the visual indicator identifies the feature on the workpiece. An optical axis of the camera that extends from the camera to the workpiece and an optical axis of the projector that extends from the projector to the workpiece are substantially parallel. The projector is fixed relative to the camera during the steps of utilizing the camera, detecting the feature, preparing the second image, and utilizing the projector. A system is also disclosed.

### CROSS-REFERENCE TO RELATED APPLICATIONS

This application claims the benefit of U.S. Provisional Application No. 63/803,675, filed May 10, 2025, the disclosure of which is incorporated herein by reference in its entirety.

### BACKGROUND

This application relates to image projection, and more particularly to a method and system for workpiece analysis and projection of images onto workpieces.

Systems, such as the DETECT-IT system from K2Ai, LLC, are available that record an image feed of a workpiece that is being worked on (e.g., assembled), display the image feed on an electronic display (e.g., an LCD display), utilize machine learning through neural networks to identify various features on the workpiece, and provide visual notifications on the electronic display to indicate a defined order of processing steps to be performed on the workpiece (e.g., a correct order of bolts that should be tightened). However, use of those systems has required workers to view a display that is separate from the workpiece itself.

### BRIEF DESCRIPTION OF THE DRAWINGS

FIG. 1 provides a first view of an example system for workpiece analysis and image projection.

FIG. 2A provides a second view of the system of FIG. 1.

FIG. 2B schematically illustrates a simplified view of an embodiment of the system of FIG. 1 that utilizes multiple cameras and multiple projectors.

FIG. 3 illustrates a bird’s-eye view of an example workpiece of FIG. 1.

FIG. 4 illustrates a bird’s-eye view of an example workpiece of FIG. 1 with visual indicators being projected onto the workpiece to identify features of the workpiece.

FIG. 5 illustrates an example method workpiece analysis and image projection.

### SUMMARY

A method according to an example embodiment of the present disclosure includes utilizing a camera that is situated above a workpiece and has a field of view that is oriented downwards onto the workpiece to record an image feed of the workpiece; detecting a location of a feature of the workpiece in at least a first image of the image feed; preparing a second image that includes a visual indicator to identify the location of the feature; and utilizing a projector that is situated above the workpiece to project the second image directly onto the workpiece such that the visual indicator identifies the location of the feature on the workpiece. An optical axis of the camera that extends from the camera to the workpiece and an optical axis of the projector that extends from the projector to the workpiece are substantially parallel to each other. The projector is fixed relative to the camera during the steps of utilizing the camera, detecting location of the feature, preparing the second image, and utilizing the projector.

In a further embodiment of the foregoing embodiment, the optical axis of the camera and the optical axis of the projector converge towards each other as they extend towards the workpiece.

In a further embodiment of any of the foregoing embodiments, the visual indicator is projected directly onto the workpiece such that the visual indicator of the second image comprises a boundary that at least partially surrounds the feature on the workpiece.

In a further embodiment of any of the foregoing embodiments, the boundary completely surrounds the feature on the workpiece.

In a further embodiment of any of the foregoing embodiments, the method includes masking the second image such that the projector does not illuminate the feature while the visual indicator is projected onto the workpiece.

In a further embodiment of any of the foregoing embodiments, the projector is a first projector, and the method includes, based on the workpiece including a feature that would interfere with or distort projection by the first projector of the boundary onto a desired surface of the workpiece, also projecting an additional visual indicator from an additional, second projector having a different orientation with respect to the workpiece than the first projector.

In a further embodiment of any of the foregoing embodiments, the method includes projecting an alignment indicator onto a work surface as an instruction for a worker about how to position the workpiece.

In a further embodiment of any of the foregoing embodiments, the method includes projecting an instruction onto the workpiece or a work surface upon which the workpiece is placed, that instructs a user about a step to perform that involves the feature.

In a further embodiment of any of the foregoing embodiments, the projected instruction is text-based.

In a further embodiment of any of the foregoing embodiments, the projected instruction comprises a video.

In a further embodiment of any of the foregoing embodiments, the detected feature is a first detected feature. The method includes verifying that an assembly step has been correctly performed on the first feature and, based on the verifying that the assembly step has been correctly performed, updating the second image to indicate successful completion of the assembly step.

A system according to an example embodiment of the present disclosure includes a projector, a camera having a field of view that is oriented downwards onto a workpiece to record an image feed of the workpiece, and processing circuitry operatively connected to memory. The processing circuitry is configured to utilize the camera to record an image feed of the workpiece from the camera, detect a location of a feature of the workpiece in at least a first image of the image feed, prepare a second image that includes a visual indicator to identify the location of the feature, and utilize the projector to project a second image directly onto the workpiece such that the visual indicator identifies the feature on the workpiece. An optical axis of the camera that extends from the camera to the workpiece and an optical axis of the projector that extends from the projector to the workpiece are substantially parallel to each other. The projector is fixed relative to the camera during the utilization of the camera to record the image feed, the detection of the location of the feature, the preparation of the second image, and the utilization of the projector to project the second image.

In a further embodiment of the foregoing embodiment, the optical axis of the camera and the optical axis of the projector converge towards each other as they extend towards the workpiece.

In a further embodiment of any of the foregoing embodiments, the projector is configured to project the visual indicator directly onto the workpiece such that the visual indicator of the second image comprises a boundary that at least partially surrounds the feature on the workpiece.

In a further embodiment of any of the foregoing embodiments, the boundary completely surrounds the feature on the workpiece.

In a further embodiment of any of the foregoing embodiments, the processing circuitry is configured to utilize the projector to mask the second image such that the projector does not illuminate the feature while the visual indicator is projected onto the workpiece.

In a further embodiment of any of the foregoing embodiments, the projector is a first projector, and the processing circuitry is configured to, based on the workpiece including a feature that would interfere with or distort projection by the first projector of the boundary onto a desired surface of the workpiece, utilize an additional second projector to project an additional visual indicator onto the workpiece, the second projector having a different orientation with respect to the workpiece than the first projector.

In a further embodiment of any of the foregoing embodiments, the projector is configured to project an alignment indicator onto a work surface as an instruction for a worker about how to position the workpiece.

In a further embodiment of any of the foregoing embodiments, the processing circuitry is configured to utilize the projector to project an instruction onto the workpiece or a work surface upon which the workpiece is placed, that instructs a user about a step to perform that involves the feature.

In a further embodiment of any of the foregoing embodiments, the projected instruction is text-based.

In a further embodiment of any of the foregoing embodiments, the projected instruction comprises a video.

In a further embodiment of any of the foregoing embodiments, the detected feature is a first detected feature. The processing circuitry is configured to verify that an assembly step has been correctly performed on the first feature and, based on the verification that the assembly step has been correctly performed, utilize the projector to update the second image to indicate successful completion of the assembly step.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

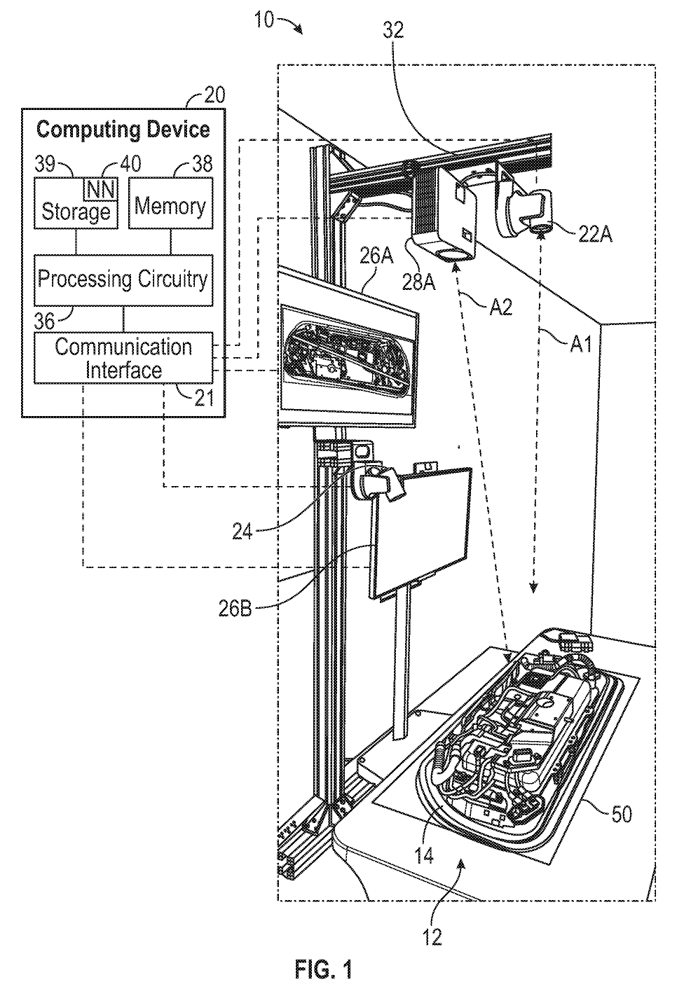

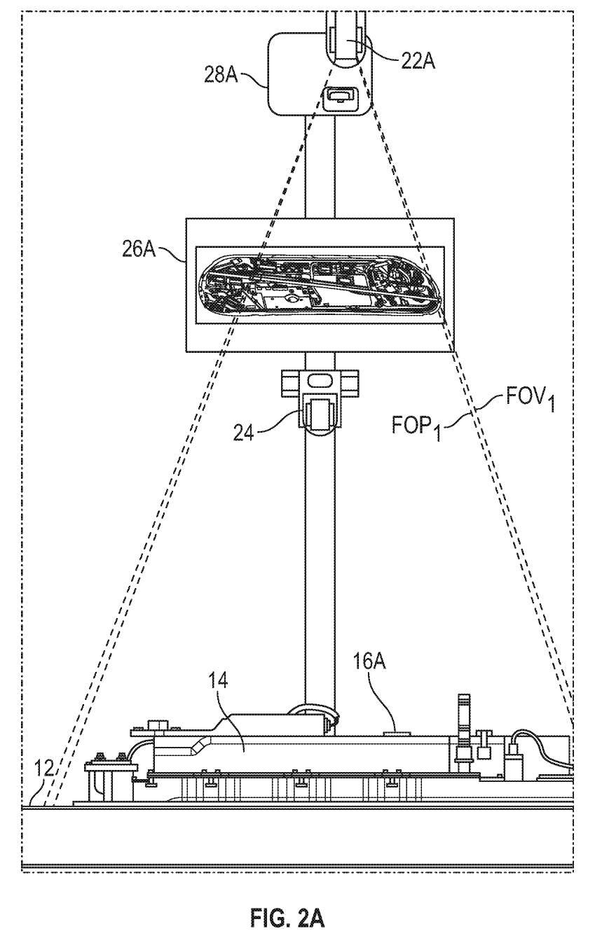

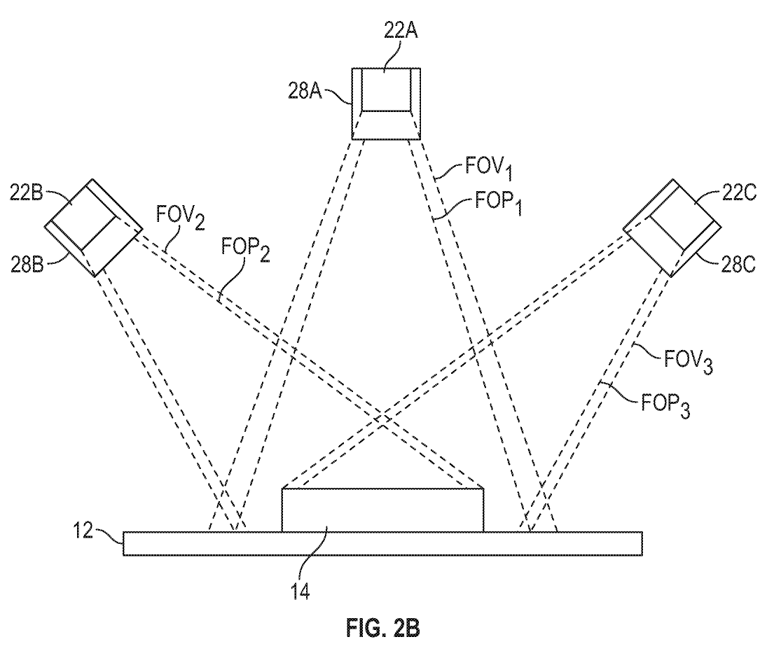

FIG. 1 provides a first view of an example system 10 for workpiece analysis and image projection, and FIG. 2A provides a second view of the system 10 of FIG. 1.

The system 10 includes a work surface / work area 12 (which in the example of FIG. 1 is a table) upon which a workpiece 14 is placed. The workpiece 14 may be a component of a machine (e.g., a vehicle component) for which some work is to be performed, such as assembly (e.g., securing two connectors together, fastening a nut to a bolt), welding, etc. In the example of FIG. 1, the workpiece is an electric vehicle (EV) battery penthouse which includes a plurality of features 16 each have an associated assembly step to be performed by a worker. Of course, it is understood that this is a non-limiting example, and that other types of workpieces could be used instead for which other work is to be performed.

A computing device 20 includes a communication interface 21 that facilitates wired and/or wireless communication between the computing device 20 and at least one camera 22A, one or more optional supplemental cameras 24 (of which one is shown in FIG. 1), one or more electronic displays 26A-B, and at least one projector 28A. The projector 28 may be bulb-based or laser-based, for example. In the example of FIGS. 1-2, the camera 22A and projector 28A are adjacent to each other, are mounted to a shared support arm 32, and are situated above the workpiece 14. The camera 22A is oriented downwards to record images of the workpiece 14, and the projector 28A is similarly oriented downwards to project images onto the workpiece 14. The camera 22A is configured to record an image feed (e.g., a video feed) of the workpiece 14, and the projector 28A is configured to project images onto the workpiece 14 for identification of the location of various the features 16 of the workpiece. The projected images are prepared based on the images of the image feed, and may be a modified version of the recorded image feed. The camera 22A may optionally be configured to pan, tilt, and/or zoom to achieve a desired alignment with the images projected by the projector 28A onto the workpiece 14.

The computing device 20 includes processing circuitry 36 that is operatively connected to the communication interface 21, memory 38 (i.e., RAM), and storage 39 (e.g., read-only memory, a hard drive, etc.). The storage 39 may include one or more neural networks 40 that are trained to identify various features in workpiece 14, e.g., that are relevant to work steps to be performed on the workpiece 14. The one or more neural networks 40 may also be trained to identify various tools used to perform assembly steps on the workpiece 14, which may be used to facilitate determination of when a correct and/or an incorrect tool is in use or is about to be used. The processing circuitry 36 includes one or more microprocessors, microcontrollers, application specific integrated circuits (ASICs), or the like configured to provide various computational features discussed herein. Although the processing circuitry 36 is depicted as being part of a single computing device 20, it is understood that the processing circuitry 36 may be distributed amongst multiple computing devices 20 if desired.

The camera 22A has an optical axis A1, and the projector 28A has an optical axis A2 that is substantially parallel to the optical axis A1, which provide for alignment of the images of the workpiece 14 recorded by the camera 22A and the images projected onto the workpiece 14 by the projector 28A. As used herein, “substantially parallel” means parallel or within 15° of being parallel. In one or more further embodiments, the axes A1, A2 are within 10° of being parallel. In one or more further embodiments, the axes A1, A2 are within 5° of being parallel. In one or more embodiments, the camera 22A and the projector 28A are oriented such that the axes A1, A2 converge towards each other as they extend towards the workpiece 14.

The camera 22A is configured and oriented to capture an image feed of a surface of the workpiece 14 on the work surface 12. The processing circuitry 36 is configured to analyze the image feed and detect at least one of the features 16 of the workpiece 14, and a corresponding location of the at least one of the features 16, in at least a first image of the image feed, and prepare a second image that includes a visual indicator that identifies the location of the at least one feature 16 when the second image is projected onto the workpiece 14. The processing circuitry 36 utilizes the projector 28A to project the second image (or the “projected image”) directly onto the workpiece 14 such that the visual indicator is projected onto or adjacent to the feature 16 on the workpiece 14 to identify the location of feature. As used herein, the projector 28A projecting “directly” onto the workpiece 14 connotes that the projector 28A projects images onto the workpiece 14 without the projected image being directed away from the optical axis by any optical manipulation devices disposed between the projector 28A and the workpiece 14 (e.g., adjustable mirrors disposed between the projector 28A and workpiece 14). In one or more embodiments, the computing device 20 also utilizes one or both of the electronic display 26A-B to depict the second image on its own, or overlaid onto the first image. The second image may be part of a projected video feed, for example.

Referring now to FIG. 2, the camera 22A has an associated field of view (“FOV”), and the projector 28A has an associated field of projection (“FOP”) that is analogous to the FOV but instead of being for recording images it is for projecting images. It is known that projectors project light, but to depict a black part of an image some projectors omit light projection for that black area. If the projector 28A was projecting light for its entire FOP, then one could tell when something has entered the FOP based on when that object becomes visibly illuminated by the projector. As shown in FIG. 2, the FOV of the camera 22A and the FOP of the projector 28A substantially overlap. In one or more embodiments there is at least a 70% overlap between the FOV and the FOP (i.e., if the work surface 12 is considered a plane, at least 70% of the FOP as measured at that plane overlaps with the FOV). In one or more further embodiments, the overlap is at least 80%. In one or more embodiments, the overlap is at least 90%. In one or more further embodiments, the overlap is at least 95%.

FIG. 2B schematically illustrates a simplified view of an embodiment of the system 10 of FIG. 1 that utilizes multiple cameras 22A-C and multiple projectors 28A-C. As shown in FIG. 2B, the projectors 28B-C each have a different orientation with respect to the workpiece 14 than the projector 28A. Cameras 22A-C have fields of view FOV₁, FOV₂, and FOV₃, respectively, and projectors 28A-C have fields of projection FOP₁, FOP₂, and FOP₃, respectively. FOV₁ and FOP₁ substantially overlap, FOV₂ and FOP₂ substantially overlap, and FOV₃ and FOP₃ substantially overlap. The degree of overlap between FOV₁ and FOP₁, FOV₂ and FOP₂, and FOV₃ and FOP₃, respectively, may correspond to any of the values described in the preceding paragraph, for example.

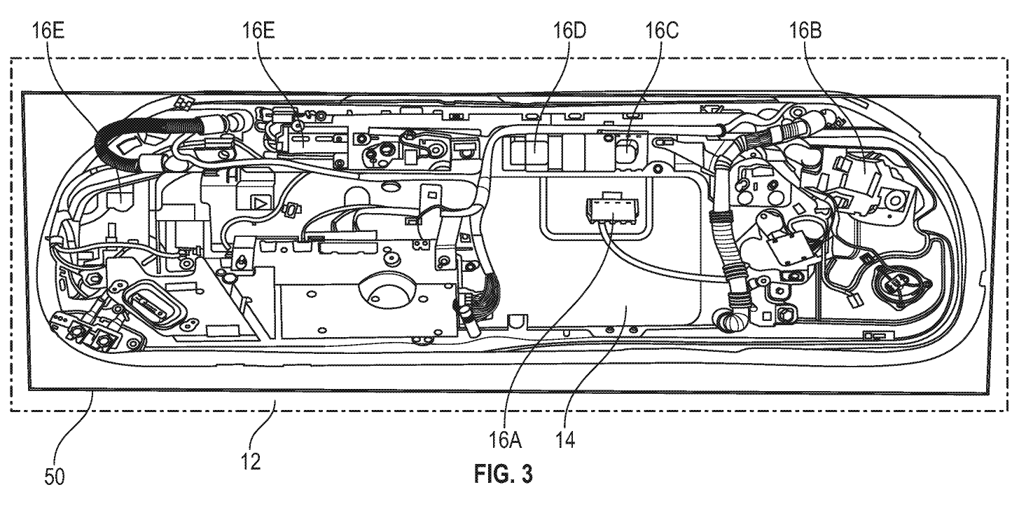

FIG. 3 illustrates bird’s-eye view of the workpiece 14 on the work surface 12 from the vantage point of a worker viewing the workpiece 14. Reference numerals 16A-E identify various features of the workpiece 14. As shown in FIG. 3, an alignment indicator 50 is projected onto the work surface 12, which in the example of FIG. 3 is a rectangular workpiece boundary that serves as an instruction / guide for a worker about how to position the workpiece 14 on the work surface 12. Other possible alignment indicators could include gridlines, for example, or the projection of an outline of the workpiece 14A. Even though one or more alignment indicators may be provided, in one or more embodiments, the computing device 20 is configured to accommodate misalignment because the one or more neural networks 40 are trained to identify the relevant features 16 of the workpiece 14 regardless of how the workpiece 16 is aligned/oriented on the work surface 12.

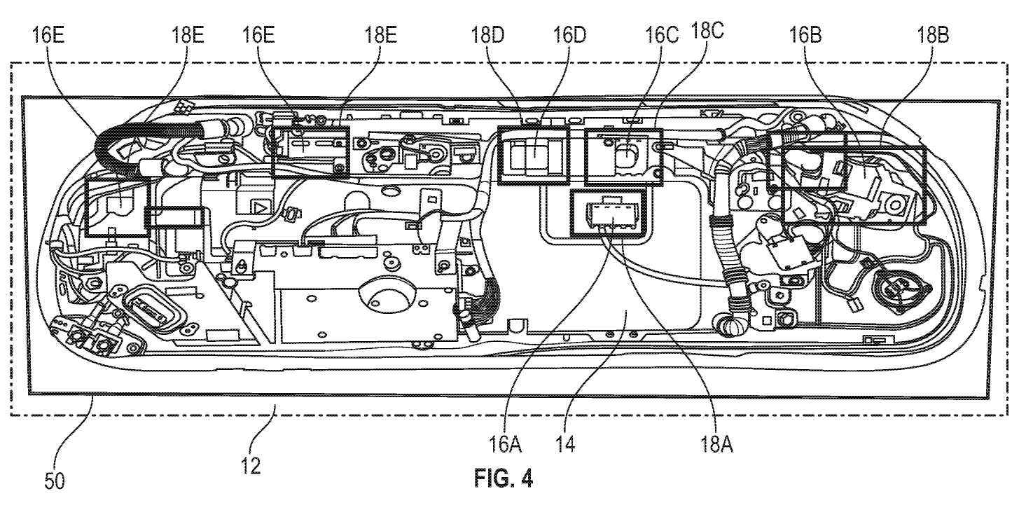

FIG. 4 illustrates a plurality of visual indicators 18A-E that are projected onto the workpiece 14 by the projector 28A and correspond to the various features 16A-E. In the example of FIG. 4, each of the visual indicators 18 is a boundary that surrounds its corresponding feature 16 on the workpiece. The visual indicators may partially or completely surround their respective corresponding features. In one or more embodiments, the feature 16 itself is not illuminated by the visual indicator 18, and the visual indicator 18 instead only surrounds the feature 16. In one or more other embodiments, the visual indicator 18 at least partially or fully overlaps its corresponding feature 16.

The additional projectors 28B and/or 28C described in FIG. 2B may be useful, for example, if the workpiece 14 includes a feature that would interfere with or distort projection by projector 28A of one of the visual indicators 18 on a desired surface of the workpiece 14. In one or more embodiments, based on the workpiece 14 including such a feature that would interfere with or distort projection by the projector 28A of a visual indicator 18 (e.g., a boundary) onto a desired surface of the workpiece 14, one or both of the projectors 28B, 28C also projects an additional visual indicator 18 from an additional, second projector having a different orientation with respect to the workpiece than the first projector 28A, so that the visual indicator 18 can be clearly viewed.

An example feature that may interfere with projection of a visual indicator 18 may include something that extends diagonally upwards away from the workpiece 14, for example, and would cause a shadow underneath on the intended projection surface of the workpiece 14. An example feature that may distort projection of a visual indicator 18 may include an uneven surface of the workpiece 14, which would cause a projected boundary to be thicker on one side due to that one side being projected onto a portion of the workpiece 14 surface that is a greater distance from the projector 28 than another side of the boundary that is projected onto a portion of the surface that is closer to the projector 28.

Most projectors do not project the color black. In one or more embodiments, the processing circuitry 36 makes areas of the second image that are not to be projected black, so that only the non-masked (non-black) areas of the second image are projected. Thus, in one or more embodiments, by using masking, the computing device 20 is able to at least partially avoid projecting the entire second image of the workpiece 14 onto the workpiece.

In one or more embodiments, the image projected onto the workpiece 16 is projected as a video feed that corresponds to the image feed recorded by the camera 22A but with masking added (e.g., to black out and prevent light transmission to areas of the workpiece outside of the visual indicator(s) 18).

In one or more embodiments, the projector 28A also projects an instruction onto the workpiece 14 to instruct a user about a step to perform that involves the feature 16. The instruction may include a symbol such as an affirmative symbol (e.g., a checkmark or the letters “OK”) to indicate one or more of the following:
a proper tool is on or in close proximity to the feature for performing an assembly step;
the feature is properly oriented (e.g., an electrical connector is properly oriented for insertion into a socket);
a next feature that should be worked on by the user according to a predefined sequence of steps

The instruction may include a negative symbol (e.g., an “X” or “NO”) to indicate one or more of the following:
an incorrect tool is on or in close proximity to the feature for performing an assembly step;
the feature is not properly oriented (e.g., an electrical connector is not properly oriented for insertion into a socket);
a user appears to be trying to perform a work step (e.g., an assembly step) in an incorrect order.

The one or more neural networks 40 may be trained to recognize tools and tool operations in order to provide the affirmative and/or negative instructions (e.g., as disclosed in US Patent No. 12,306,614) to support the instructions discussed above.

The instruction may be projected onto the workpiece 14 and/or the work surface 12 adjacent to the relevant feature, for example. In one or more embodiments, the instruction is text-based (e.g., “Incorrect Tool” or an instruction to select a particular tool, such as a particular torque wrench to be used) or includes a video (e.g., projecting a video to indicate an instruction related to the feature 16 and/or a step to be performed on the feature 16).

The workpiece 14 may have a defined sequence of steps that are to be performed by a worker, such as one operation to be performed for each feature 16A-E (e.g., tighten first bolt, tighten second bolt, and so forth). The computing device 20 may be configured to detect that a work step has been correctly performed on a detected first feature for which an image is projected, and then update the image being projected to indicate completion of that step and also identify a next feature in the sequence, and may continue doing this until the sequence of steps for the workpiece 14 is complete. In one or more embodiments, the features 16 can be identified in an order corresponding to a sequence of steps to be performed on the workpiece 14 (e.g., identify feature 16A first, then feature 16B, then feature 16C) to indicate to the worker the sequence of steps that are to be performed. Thus, the computing device 20 may verify that an assembly step has been correctly performed on a particular feature, and based on that verification, update the projected image feed to indicate successful completion of the assembly step. The instruction information projected onto the workpiece 14 may include information such as tool identification, feature numbering, or other information relevant to a worker.

As discussed above, the system 10 may utilize more cameras 28 than the main overhead camera 22A. For example, as shown in FIG. 2B, additional cameras 28B and/or 28C may be used. Also, one or more supplemental cameras 24 that are disposed closer to the workpiece 14 than the camera 22A may be used by the processing circuitry 36 for viewing finer details that can’t be seen sufficiently from the camera 22A, and the processing circuitry 36 may then utilize image(s) from the one or more supplemental cameras 24 for feature 16 identification. Although only one supplemental camera 24 is shown, it is understood that different quantities of supplemental cameras could be used.

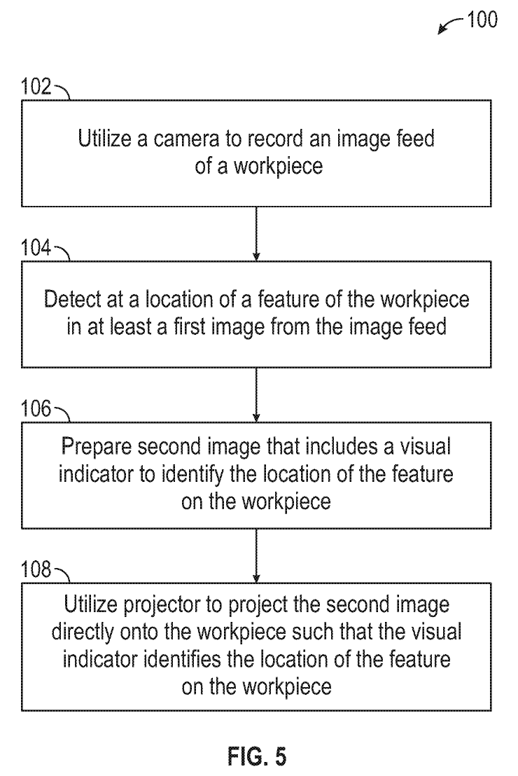

FIG. 5 illustrates an example method 100 for workpiece 14 analysis and image projection. The method 100 may be performed by the processing circuitry 36, for example. A camera (e.g., camera 22A) is utilized to record an image feed of a workpiece 14 (step 102). In the example of FIG. 1, this is an upper surface of the workpiece 14. One or more neural networks 40 are utilized to detect a location of a feature 16 of the workpiece 14 in at least a first image from the image feed (step 104). Of course, as discussed above, this may include identifying locations of a plurality of features from the first image and/or the locations of the feature(s) 16 may be identified in multiple images from the image feed. A second image is prepared that includes a visual indicator to identify the detected location of the detected feature (step 106). The projector 28A is utilized to project the second image directly onto the workpiece 14 such that the visual indicator identifies the location of the feature on the workpiece 14. In one or more embodiments, the projector 28A is fixed relative to the camera 22A steps 102-108 (e.g., through the camera 22A and projector 28A both being mounted to the same support arm 32). These steps may then be repeated to guide a worker through a plurality of work steps for the workpiece 14.

By projecting images directly onto the workpiece 14, the system 10 is able to improve worker effectiveness by reducing a time needed for the worker to look away from the workpiece 14 to a display (e.g., display 26A and/or 26B), and to further reduce the possibility of worker error, especially if there are numerous features 16 on the workpiece 14 that need to be worked on by the worker. This may increase worker efficiency, and may also prevent strain from repetitive neck motion by enabling a worker to stay focused on the workpiece 14 instead of repeatedly looking up at the display 26A and/or 26B.

In one or more embodiments, the neural network(s) 40 are trained to determine reflectivity of various areas of the workpiece 14, and to determine how to project based on that material (e.g., use first type of projection for a first type of material, and use a second type of projection for a second type of material that is more or less reflective of light). In such embodiments, the computing device 20 may adjust how its images are projected based on the reflectivity of the materials.

In one or more embodiments, the system 10 is able to perform automatic calibration when a current workpiece 14 is removed from the work area 12 and a new workpiece 14 is introduced into the work area 12. If the new workpiece 14 is positioned slightly differently than the previous workpiece 14 (e.g., is rotated with respect to the previous workpiece 14), the system 10 is configured to accommodate that different positioning because the projected image is determined based on the recorded image from camera 22A, and the recorded image would reflect the different positioning.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A method, comprising:
utilizing a camera that is situated above a workpiece and has a field of view that is oriented downwards onto the workpiece to record an image feed of the workpiece;
detecting a location of a feature of the workpiece in at least a first image of the image feed;
preparing a second image that includes a visual indicator to identify the detected location of the feature; and
utilizing a projector that is situated above the workpiece to project the second image directly onto the workpiece such that the visual indicator identifies the location of the feature on the workpiece;
wherein an optical axis of the camera that extends from the camera to the workpiece and an optical axis of the projector that extends from the projector to the workpiece are substantially parallel to each other; and
wherein the projector is fixed relative to the camera during said steps of utilizing the camera, detecting the location of the feature, preparing the second image, and utilizing the projector.

2. The method of claim 1, wherein the optical axis of the camera and the optical axis of the projector converge towards each other as they extend towards the workpiece.

3. The method of claim 1, wherein the visual indicator is projected directly onto the workpiece such that the visual indicator of the second image comprises a boundary that at least partially surrounds the feature on the workpiece.

4. The method of claim 3, wherein the boundary completely surrounds the feature on the workpiece.

5. The method of claim 3, comprising:
masking the second image such that the projector does not illuminate the feature while the visual indicator is projected onto the workpiece.

6. The method of claim 3, wherein the projector is a first projector, and the method comprises:
based on the workpiece including a feature that would interfere with or distort projection by the first projector of the boundary onto a desired surface of the workpiece, also projecting an additional visual indicator from an additional, second projector having a different orientation with respect to the workpiece than the first projector.

7. The method of claim 1, comprising:
projecting an alignment indicator onto a work surface as an instruction for a worker about how to position the workpiece.

8. The method of claim 1, comprising:
projecting an instruction onto the workpiece or a work surface upon which the workpiece is placed, that instructs a user about a step to perform that involves the feature.

9. The method of claim 7, wherein the projected instruction is text-based or includes video.

10. The method of claim 1, wherein the detected feature is a first detected feature, the method comprising:
verifying that an assembly step has been correctly performed on the first feature; and
based on the verifying that the assembly step has been correctly performed, updating the second image to indicate successful completion of the assembly step.

11. A system, comprising:
a projector;
a camera having a field of view that is oriented downwards onto a workpiece to record an image feed of the workpiece; and
processing circuitry operatively connected to memory and configured to:
utilize the camera to record an image feed of the workpiece from the camera;
detect a location of feature of the workpiece in at least a first image of the image feed;
prepare a second image that includes a visual indicator to identify the location of the feature; and
utilize the projector to project a second image directly onto the workpiece such that the visual indicator identifies the feature on the workpiece;
wherein an optical axis of the camera that extends from the camera to the workpiece and an optical axis of the projector that extends from the projector to the workpiece are substantially parallel to each other; and
wherein the projector is fixed relative to the camera during the utilization of the camera to record the image feed, the detection of the location of the feature, the preparation of the second image, and the utilization of the projector to project the second image.

12. The system of claim 11, wherein the optical axis of the camera and the optical axis of the projector converge towards each other as they extend towards the workpiece.

13. The system of claim 11, wherein the projector is configured to project the visual indicator directly onto the workpiece such that the visual indicator of the second image comprises a boundary that at least partially surrounds the feature on the workpiece.

14. The system of claim 13, wherein the boundary completely surrounds the feature on the workpiece.

15. The system of claim 13, wherein the processing circuitry is configured to utilize the projector to:
mask the second image such that the projector does not illuminate the feature while the visual indicator is projected onto the workpiece.

16. The system of claim 13, wherein the projector is a first projector, and the processing circuitry is configured to:
based on the workpiece including a feature that would interfere with or distort projection by the first projector of the boundary onto a desired surface of the workpiece, utilize an additional second projector to project an additional visual indicator onto the workpiece, the second projector having a different orientation with respect to the workpiece than the first projector.

17. The system of claim 11, wherein the projector is configured to:
project an alignment indicator onto a work surface as an instruction for a worker about how to position the workpiece.

18. The system of claim 11, wherein the processing circuitry is configured to utilize the projector to:
project an instruction onto the workpiece or a work surface upon which the workpiece is placed, that instructs a user about a step to perform that involves the feature.

19. The system of claim 17, wherein the projected instruction is text-based or includes video.

20. The system of claim 11, wherein:
the detected feature is a first detected feature; and
the processing circuitry is configured to:
verify that an assembly step has been correctly performed on the first feature; and
based on the verification that the assembly step has been correctly performed, utilize the projector to update the second image to indicate successful completion of the assembly step.
